(19) United States
(12) Patent Application Publication
(10) Pub. No.: US 2024/0421526 A1
(43) Pub. Date: Dec. 19, 2024

(54) Charging Seat Lead Frame, Charging Seat Lead Frame Assembly and Charging Seat

(71) Applicants: Tyco Electronics (Suzhou) Ltd., Suzhou City (CN); Tyco Electronics Technology (SIP) Co., Ltd., Suzhou (CN); Tyco Electronics (Shanghai) Co., Ltd, Shanghai (CN)

(72) Inventors: Jianwei Qi, Suzhou (CN); Fangyue (jason) Zhu, Sganghai (CN); Jinshun (Jet) Wang, Suzhou (CN)

(73) Assignees: Tyco Electronics (Suzhou) Ltd., Suzhou City (CN); Tyco Electronics Technology (SIP) Co., Ltd., Suzhou (CN); Tyco Electronics (Shanghai) Co., Ltd, Shanghai (CN)

(21) Appl. No.: 18/743,197

(22) Filed: Jun. 14, 2024

(30) Foreign Application Priority Data
Jun. 16, 2023 (CN) 202321552078.5

(51) Int. Cl. H01R 13/50; H01R 13/533; H01R 13/627; H01R 13/631; H01R 13/66

(52) U.S. Cl. CPC H01R 13/50; H01R 13/533; H01R 13/6273; H01R 13/631; H01R 13/6616; H01R 13/6683

(57) ABSTRACT

A charging seat lead frame comprises a frame body and a first electrical connection member. The first electrical connection member includes a first elastic clamp and a first connection part. The first elastic clamp includes a pair of elastic arms exposed from the frame body for clamping a first signal terminal. The first connection part is fixed in the frame body and is connected to the pair of elastic arms of the first elastic clamp. A support part is formed on the frame body and protrudes towards the end part of the elastic arm to limit the deformation amount of the elastic arm.

### CROSS-REFERENCE TO RELATED APPLICATION

This application claims the benefit of Chinese Patent Application No. CN202321552078.5 filed on Jun. 16, 2023, in the State Intellectual Property Office of China, the whole disclosure of which is incorporated herein by reference.

### FIELD OF THE INVENTION

Embodiments of the present disclosure relate to a charging seat lead frame, a charging seat lead frame assembly comprising the charging seat lead frame, and a charging seat including the charging seat lead frame assembly.

### BACKGROUND

In the prior art, a charging seat typically includes a housing, signal terminals, power terminals, and a lead frame. The lead frame includes a frame body and an electrical connection member (also known as a lead) set in the frame body for electrical connection with signal terminals. In the prior art, the signal terminal includes a PE terminal (ground protection terminal) and a CP terminal (charging control terminal), with a resistor connected in series between the PE terminal and the CP terminal. The electrical connection member connected to the PE terminal includes an elastic clamp for clamping the PE terminal. In the prior art, there is no limit structure on the frame body to limit deformation of the elastic clamp. Therefore, the elastic clamp is at risk of plastically deforming. Once the elastic clamp undergoes plastic deformation, it will cause unstable contact between the elastic clamp and the PE terminal, resulting in unstable resistance testing and affecting the normal operation of the system.

### SUMMARY

According to an embodiment of the present disclosure, a charging seat lead frame comprises a frame body and a first electrical connection member. The first electrical connection member includes a first elastic clamp and a first connection part. The first elastic clamp includes a pair of elastic arms exposed from the frame body for clamping a first signal terminal. The first connection part is fixed in the frame body and is connected to the pair of elastic arms of the first elastic clamp. At least one support part is formed on the frame body and protrudes towards the end part of at least one of the elastic arms to limit the deformation amount of the elastic arm.

### BRIEF DESCRIPTION OF THE DRAWINGS

The invention will now be described by way of example with reference to the accompanying Figures, of which:

FIG. 1 shows an illustrative perspective view of a charging seat lead frame assembly according to an exemplary embodiment of the present invention;

FIG. 2 shows a plan view of the charging seat lead frame assembly according to an exemplary embodiment of the present invention when viewed from the top;

FIG. 3 shows a plan view of the charging seat lead frame assembly according to an exemplary embodiment of the present invention when viewed from the bottom;

FIG. 4 shows an illustrative exploded view of a charging seat lead frame assembly according to an exemplary embodiment of the present invention;

FIG. 5 shows an illustrative perspective view of the frame body of a charging seat lead frame assembly according to an exemplary embodiment of the present invention;

FIG. 6 shows an illustrative perspective view of the electrical connection member, resistor, and temperature sensor of the charging seat lead frame assembly according to an exemplary embodiment of the present invention;

FIG. 7 shows an illustrative perspective view of the first electrical connection member of the charging seat lead frame assembly according to an exemplary embodiment of the present invention; and

FIG. 8 shows an illustrative perspective view of the thermal conductive pad and temperature sensor of the charging seat lead frame assembly according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown to simplify the drawing.

According to an embodiment of the present disclosure, a charging seat lead frame comprises a frame body and a first electrical connection member. The first electrical connection member includes a first elastic clamp comprising a pair of elastic arms exposed from the frame body for clamping a first signal terminal, and a first connection part which is fixed in the frame body and connected to the pair of elastic arms of the first elastic clamp. A support part is formed on the frame body and protrudes towards the end part of the elastic arm to limit the deformation amount of the elastic arm.

According to embodiment, a charging seat lead frame assembly comprises the above charging seat lead frame, and a resistor which is installed on the frame body of the charging seat lead frame. Two ends of the resistor are respectively electrically connected to the first electrical connection member and the second electrical connection member of the charging seat lead frame. A charging seat according to another embodiment of the present disclosure includes a charging seat housing, and the charging seat lead frame assembly installed in the charging seat housing.

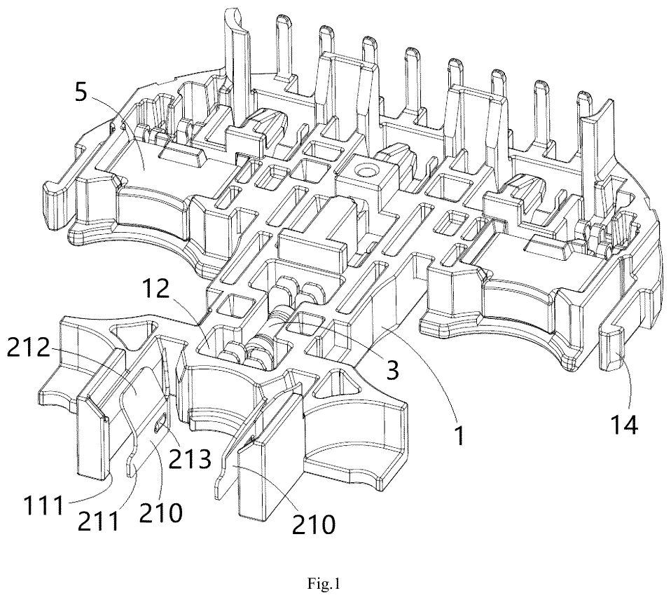

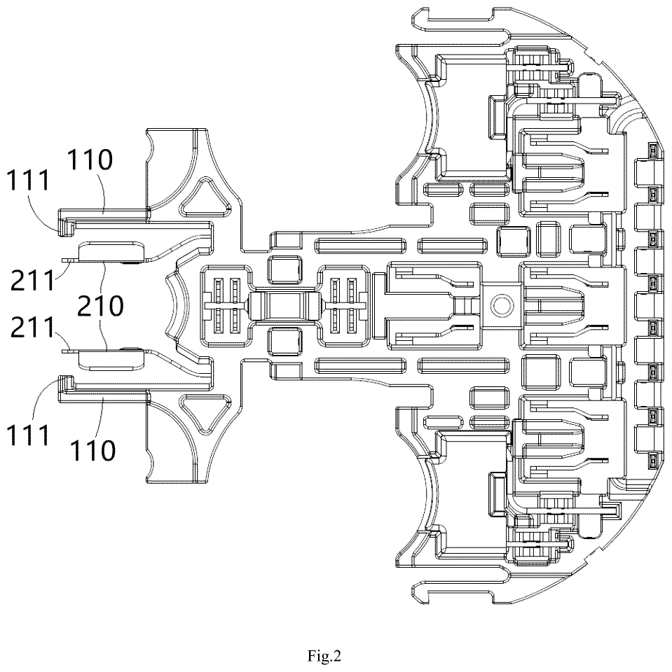

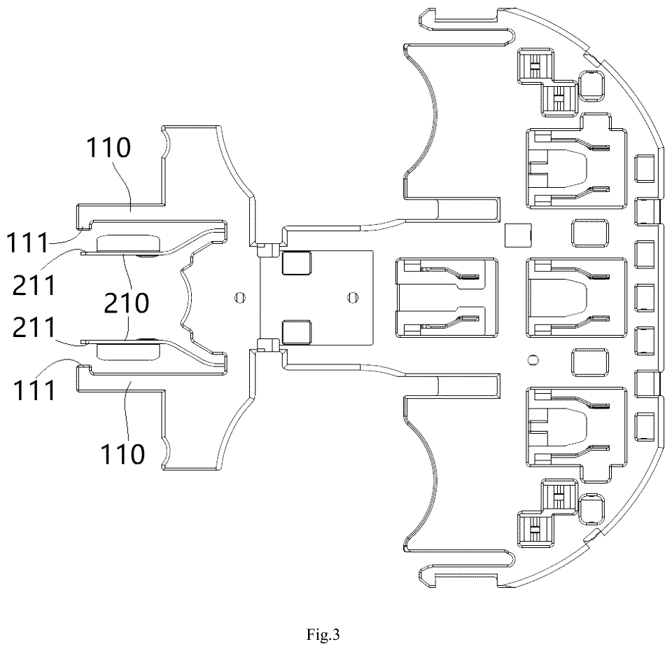

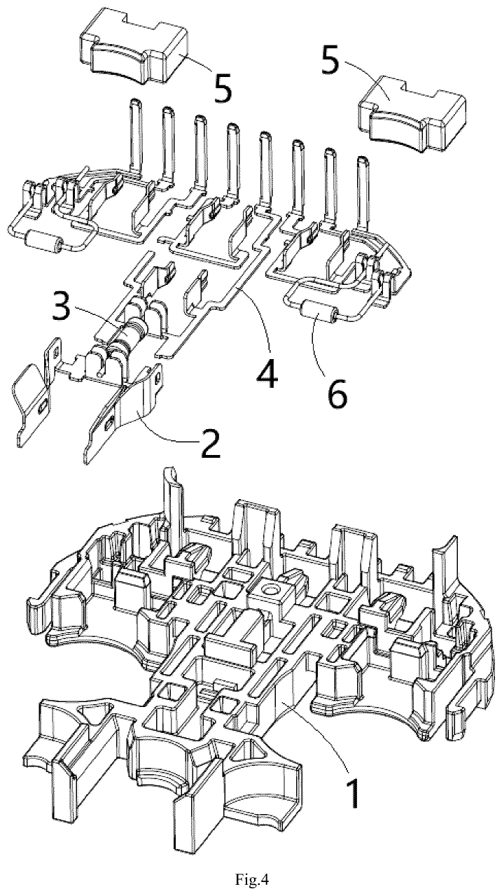

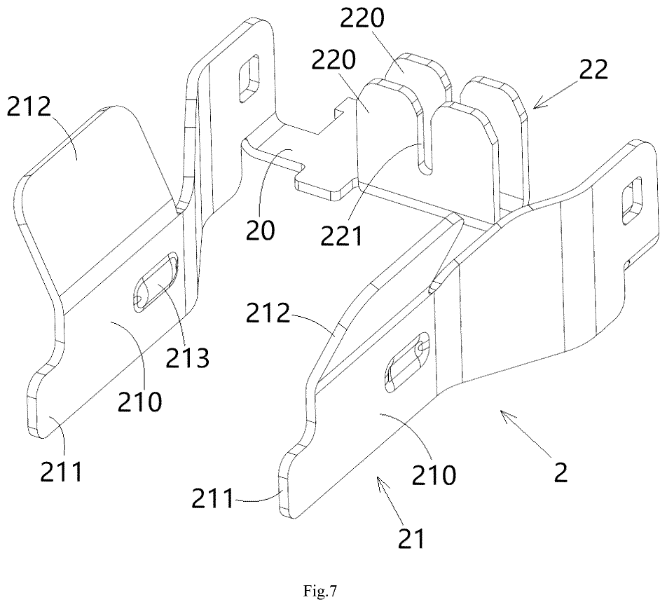

FIG. 1 shows an illustrative perspective view of a charging seat lead frame assembly according to an exemplary embodiment of the present disclosure. FIG. 2 shows a plan view of the charging seat lead frame assembly according to an exemplary embodiment of the present disclosure when viewed from the top. FIG. 3 shows a plan view of the charging seat lead frame assembly according to an exemplary embodiment of the present disclosure when viewed from the bottom; FIG. 4 shows an illustrative exploded view of a charging seat lead frame assembly according to an exemplary embodiment of the present invention. FIG. 7 shows an illustrative perspective view of the first electrical connection member 2 of the charging seat lead frame assembly according to an exemplary embodiment of the present disclosure.

As shown in FIGS. 1-4 and 7, in an exemplary embodiment of the present disclosure, a charging seat lead frame is provided. The charging seat lead frame mainly includes a frame body 1 and a first electrical connection member 2. The first electrical connection member 2 includes a first elastic clamp 21 and a first connection part 20. The first elastic clamp 21 includes a pair of elastic arms 210 exposed from the frame body 1, which are used to clamp the first signal terminal (not shown) of the charging seat. The first connection part 20 is fixed in the frame body 1 and connected to the pair of elastic arms 210 of the first elastic clamp 21.

As shown in FIGS. 1-4 and 7, in the illustrated embodiments, a support part 111 is formed on the frame body 1 and protrudes towards the end part 211 of the elastic arm 210. The support part 111 is used to rest against the end part 211 of the elastic arm 210 to limit the deformation amount of the elastic arm 210. In this way, it can effectively prevent plastic deformation of the elastic clamp 21 and improve the electrical contact stability and reliability of the charging seat product.

The frame body 1 comprises a main body 10 and a pair of supporting arms 110 extending from the main body 10. The pair of elastic arms 210 are provided between the pair of support arms 110. The support part 111 is formed at the end of the support arm 110 and protrudes at a predetermined height towards the end part 211 of the elastic arm 210.

The first electrical connection member 2 further comprises a pair of guide wings 212, which are respectively connected to the side edges of the pair of elastic arms 210 and splayed outward to guide the first signal terminal to be inserted between the pair of elastic arms 210. The end part 211 of the elastic arm 210 extends forward beyond the front edge of the guiding wing 212. The support part 111 is located in front of the guide wing 212 and is spaced at a predetermined distance from the guide wing 212. In the illustrated embodiments, a contact protrusion 213 is formed on the inner side surface of the elastic arm 210. The contact protrusion 213 is adapted to elastically contact the first signal terminal inserted between the pair of elastic arms 210.

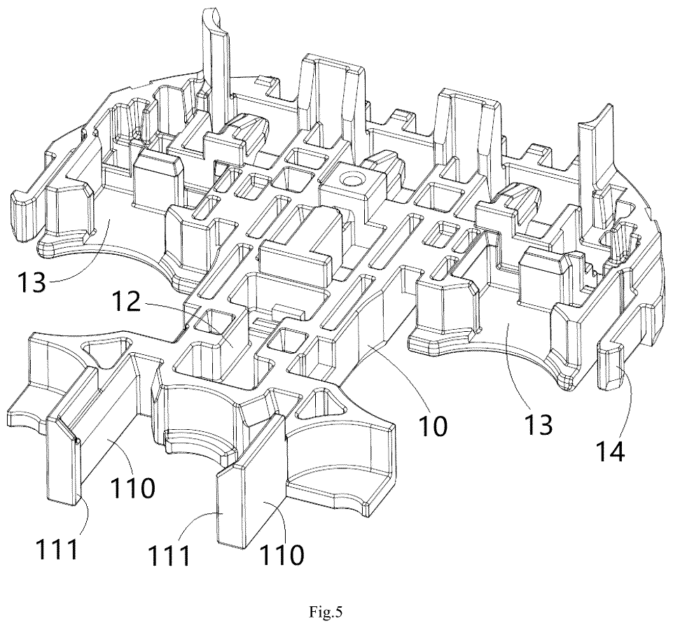

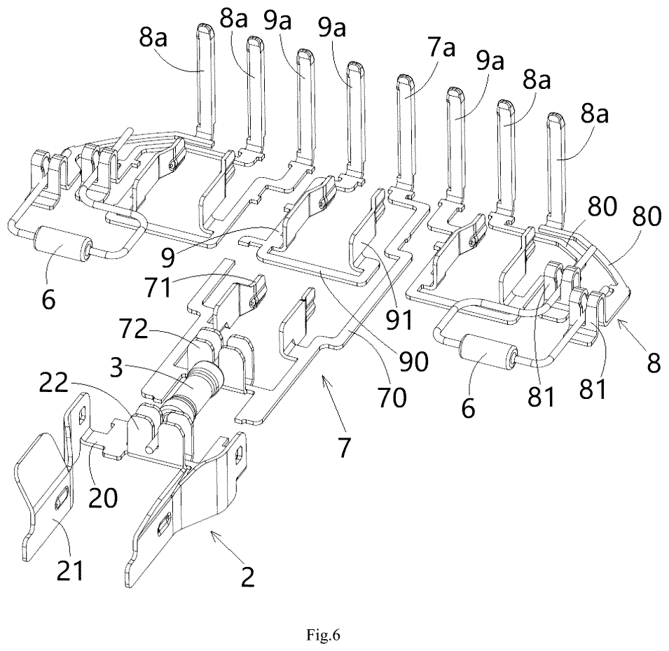

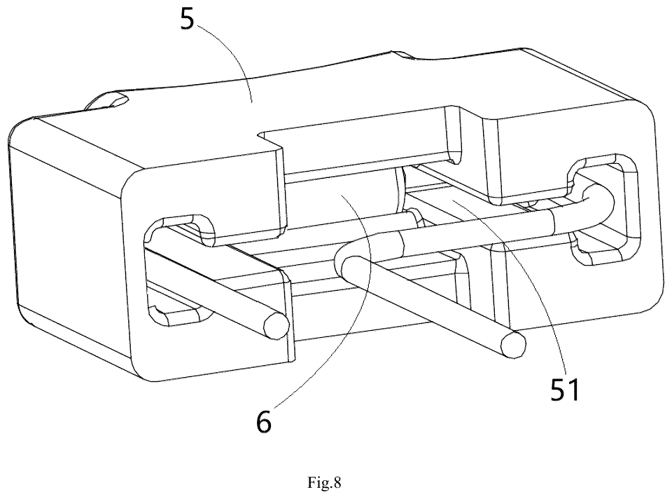

FIG. 5 shows an illustrative perspective view of the frame body 1 of a charging seat lead frame assembly according to an exemplary embodiment of the present disclosure. FIG. 6 shows an illustrative perspective view of the electrical connection members 2, 7, 8, 9, resistor 3, and temperature sensor 6 of the charging seat lead frame assembly according to an exemplary embodiment of the present disclosure. FIG. 8 shows an illustrative perspective view of the thermal conductive pad 5 and temperature sensor 6 of the charging seat lead frame assembly according to an exemplary embodiment of the present disclosure.

As shown in FIGS. 1-8, in the illustrated embodiment, the first electrical connection member 2 further includes a first terminal part 22, which is connected to the first connection part 20 for electrical connection with one end of the resistor 3 installed on the frame body 1. The first terminal part 22 comprises a pair of terminal plates 220, on which a snap slot 221 is formed for holding the pin of the resistor 3. A chamber 12 is formed in the main body 10 of the frame body 1 to accommodate the resistor 3, and the first terminal part 22 is located in the chamber 12.

The charging seat lead frame further includes a second electrical connection member 7, which is used for electrical connection with the other end of the resistor 3 and the second signal terminal. The second electrical connection member 7 mainly comprises a second elastic clamp 71, a second terminal part 72, a second connection part 70 and a second output end 7a. The second elastic clamp 71 is exposed from the frame body 1 and is used to clamp a second signal terminal (not shown). The second terminal part 72 is located in the chamber 12 and is used for electrical connection to the other end of the resistor 3. The second connection part 70 is fixed in the frame body 1 and connected to the second elastic clamp 71 and the second terminal part 72. The second output end 7a is connected to one end of the second connection part 70.

The charging seat lead frame further includes at least one third electrical connection member 9 for respectively electrically connecting with at least one third signal terminal (not shown). The third electrical connection member 9 comprises a third elastic clamp 91, a third connection part 90, and a third output end 9a. The third elastic clamp 91 is exposed from the frame body 1 and is used to clamp a third signal terminal. The third connection part 90 is fixed in the frame body 1 and connected to the third elastic clamp 91. The third output end 9a is connected to one end of the third connection part 90.

The charging seat lead frame further includes a fourth electrical connection member 8, which is used for electrical connection with a temperature sensor 6 installed on the frame body 1. The fourth electrical connection member 8 includes a fourth terminal part 81, a fourth connection part 80, and a fourth output end 8a. The fourth terminal 81 is exposed from the frame body 1 and is used for electrical connection with the pins of temperature sensor 6. The fourth connection part 80 is fixed in the frame body 1 and connected to the fourth terminal part 81. The fourth output end 8a is connected to one end of the fourth connection part 80.

An elastic locking buckle 14 is formed on the frame body 1, which is suitable for engagement with the charging seat housing (not shown) to lock the charging seat lead frame to the charging seat housing.

In the illustrated embodiments, the second output end 7a, the third output end 9a, and the fourth output end 8a are arranged in a row for mating with terminals in the connector (not shown).

As shown in FIGS. 1-8, in another exemplary embodiment of the present disclosure, a charging seat lead frame assembly is also disclosed. The charging seat lead frame assembly mainly includes the aforementioned charging seat lead frame and a resistor 3. The resistor 3 is installed onto the frame body 1 of the charging seat lead frame. The two ends of resistor 3 are respectively electrically connected to the first electrical connection member 2 and the second electrical connection member 7 of the charging seat lead frame.

The charging seat lead frame assembly further comprises a thermal conductive pad 5 and a temperature sensor 6. The thermal conductive pad 5 is installed in an installation chamber 13 of the frame body 1, for thermal contact with a power terminal (not shown or referred to as the charging terminal). The temperature sensor 6 is inserted into a slot 501 formed in the thermal conductive pad 5 to detect the temperature of the power terminal. The two ends of temperature sensor 6 are electrically connected to two fourth electrical connection members 8 of the charging seat lead frame.

In another exemplary embodiment of the present invention, a charging seat is also disclosed. The charging seat includes a charging seat housing and the charging seat lead frame assembly as described above. The charging seat lead frame assembly is installed in the charging seat housing. The charging seat comprises a first signal terminal, a second signal terminal, and a third signal terminal. The first signal terminal is installed in the charging seat housing and electrically connected to the first electrical connection member 2 of the charging seat lead frame. The second signal terminal is installed in the charging seat housing and electrically connected to the second electrical connection member 7 of the charging seat lead frame. The third signal terminal is installed in the charging seat housing and electrically connected to the third electrical connection member 9 of the charging seat lead frame. In the illustrated embodiments, the first signal terminal is the grounding protection terminal of the charging seat, and the second signal terminal is the charging control terminal of the charging seat.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A charging seat lead frame, comprising:
a frame body including a pair of support parts formed thereon; and
a first electrical connection member, including:
a first elastic clamp having a pair of elastic arms exposed from the frame body and adapted to clamp a first signal terminal; and
a first connection part fixed in the frame body and connected to the pair of elastic arms of the first elastic clamp, each support part protrudes towards a respective end part of the elastic arms to limit the deformation amount of the elastic arms.

2. The charging seat lead frame according to claim 1, wherein:
the frame body includes a main body and a pair of supporting arms extending from the main body, the pair of elastic arms are arranged between the pair of supporting arms; and
each support part is formed at the end of one of the support arms and protrudes at a predetermined height towards the end part of the elastic arm.

3. The charging seat lead frame according to claim 1, wherein the first electrical connection member further comprises a pair of guiding wings connected to side edges of the pair of elastic arms and splayed outward to guide the first signal terminal to be inserted between the pair of elastic arms.

4. The charging seat lead frame according to claim 3, wherein:
the end part of each elastic arm extends forward beyond a front edge of the guide wing; and
each support part is located in front of the guiding wing and is spaced at a predetermined distance from the guiding wing.

5. The charging seat lead frame according to claim 1, wherein a contact protrusion is formed on an inner side surface of each elastic arm and is adapted to electrically contact the first signal terminal inserted between the pair of elastic arms.

6. The charging seat lead frame according to claim 1, wherein the first electrical connection member further comprises a first terminal part connected to the first connection part and electrically connected to one end of a resistor installed on the frame body.

7. The charging seat lead frame according to claim 6, wherein the first terminal part comprises a pair of terminal plates, a snap slot is formed on the terminal plate for holding the pin of the resistor.

8. The charging seat lead frame according to claim 6, wherein a chamber is formed in the main body of the frame body to accommodate the resistor, and the first terminal part is located in the chamber.

9. The charging seat lead frame according to claim 8, further comprising a second electrical connection member adapted to electrically connect with the other end of the resistor and the second signal terminal.

10. The charging seat lead frame according to claim 9, wherein the second electrical connection member comprises:
a second elastic clamp exposed from the frame body for clamping a second signal terminal;
a second terminal part arranged in the chamber for electrically connecting with the other end of the resistor;
a second connection part fixed in the frame body and connected to the second elastic clamp and the second terminal part; and
a second output end connected to one end of the second connection part.

11. The charging seat lead frame according to claim 1, further comprising at least one third electrical connection member for respectively electrically connecting with at least one third signal terminal.

12. The charging seat lead frame according to claim 11, wherein the third electrical connection member comprises:
a third elastic clamp exposed from the frame body for clamping the third signal terminal;
a third connection part fixed in the frame body and connected to the third elastic clamp; and
a third output end connected to one end of the third connection part.

13. The charging seat lead frame according to claim 1, further comprising a fourth electrical connection member adapted to electrically connect with a temperature sensor installed on the frame body, comprising:
a fourth terminal part exposed from the frame body for electrical connection with the pin of the temperature sensor;
a fourth connection part fixed in the frame body and connected to the fourth terminal part; and
a fourth output end which is connected to one end of the fourth connection part.

14. The charging seat lead frame according to claim 1, wherein an elastic locking buckle is formed on the frame body and adapted to engage with a charging seat housing to lock the charging seat lead frame to the charging seat housing.

15. A charging seat lead frame assembly, comprising:
a charging seat lead frame, including:
a frame body including a pair of support parts formed thereon; and
a first electrical connection member, including:
a first elastic clamp having a pair of elastic arms exposed from the frame body and adapted to clamp a first signal terminal; and
a first connection part fixed in the frame body and connected to the pair of elastic arms of the first elastic clamp, each support part protrudes towards a respective end part of the elastic arms to limit the deformation amount of the elastic arms; and
a resistor installed on the frame body of the charging seat lead frame, wherein two ends of the resistor are electrically connected to respective ones of the first electrical connection member and the second electrical connection member of the charging seat lead frame.

16. The charging seat lead frame assembly according to claim 15, further comprising:
a thermal conductive pad which in an installation chamber of the frame body and adapted to thermally contact a power terminal; and
a temperature sensor inserted into a slot formed in the thermal conductive pad and adapted to detect a temperature of the power terminal, wherein two ends of the temperature sensor are electrically connected to two fourth electrical connection members of the charging seat lead frame.

17. A charging seat, comprising:
a charging seat housing; and
a charging seat lead frame assembly installed in the charging seat housing, including:
a charging seat lead frame, having
a frame body including a pair of support parts formed thereon; and
a first electrical connection member, comprising:
a first elastic clamp having a pair of elastic arms exposed from the frame body and adapted to clamp a first signal terminal; and
a first connection part fixed in the frame body and connected to the pair of elastic arms of the first elastic clamp, each support part protrudes towards a respective end part of the elastic arms to limit the deformation amount of the elastic arms; and
a resistor installed on the frame body of the charging seat lead frame, wherein two ends of the resistor are electrically connected to respective ones of the first electrical connection member and the second electrical connection member of the charging seat lead frame.

18. The charging seat according to claim 17, further comprising:
a first signal terminal installed in the charging seat housing and electrically connected to the first electrical connection member of the charging seat lead frame; and
a second signal terminal which in the charging seat housing and electrically connected to the second electrical connection member of the charging seat lead frame.

19. The charging seat according to claim 18, further comprising a third signal terminal installed in the charging seat housing and electrically connected to the third electrical connection member of the charging seat lead frame.

20. The charging seat according to claim 18, wherein the first signal terminal is a grounding protection terminal of the charging seat, and the second signal terminal is a charging control terminal of the charging seat.
